(19) United States
(12) Patent Application Publication
(10) Pub. No.: US 2025/0279709 A1
(43) Pub. Date: Sep. 4, 2025

(54) LINEAR VIBRATION MOTOR AND ELECTRONIC DEVICE

(71) Applicant: AAC Technologies Pte. Ltd., Singapore (SG)

(72) Inventor: Kazuo Shikama, Osaka (JP)

(21) Appl. No.: 18/810,469

(22) Filed: Aug. 20, 2024

(30) Foreign Application Priority Data
Mar. 4, 2024 (JP) 2024-032229

(51) Int. Cl. H02K 33/18

(52) U.S. Cl. CPC H02K 33/18

(57) ABSTRACT

Provided are a linear vibration motor and an electronic device. In a receiving space enclosed by a case, a follower is at a support frame of a vibrator, and a driver is opposite to the follower for driving the follower to drive the support frame to move along a straight line. The support frame is provided with receiving grooves. Each receiving groove is provided with at least one support member, part of which is located outside the receiving groove. The support member is pressed against the case by the support frame and configured to support the support frame. When the driver drives the support frame to move relative to the case, the support member rolls relative to the case and the support frame, the support frame stably moves, and the receiving groove is located in the receiving space and does not deform due to an influence of any impact.

### TECHNICAL FIELD

The present disclosure relates to the technical field of vibration motors, in particular to a linear vibration motor and an electronic device.

### BACKGROUND

With the development of electronic technologies, portable electronic devices such as smart phones and handheld game consoles are becoming more and more popular. Most electronic devices use linear vibration motors as feedback devices of the system, such as incoming call prompts, information prompts, navigation prompts, and vibration feedback of game consoles.

An existing linear vibration motor usually uses a leaf spring as a support member of a vibrator, and an elastic leaf spring is an excellent device for fixing and supporting the vibrator. However, the impact resistance and vibration resistance of the leaf spring are poor, and when the leaf spring is subjected to falling impact or reciprocating motion/vibration caused by repeated vibration of the motor, the leaf spring is prone to deformation and damage, so that the linear vibration motor using the leaf spring as a support member has poor performance in falling tests and life tests, and is also prone to problems in practical applications. In view of the problems existing in the leaf spring, the leaf spring with good vibration resistance and impact resistance is usually manufactured by changing the thickness of the leaf spring or changing the material of the leaf spring, however, it is very difficult to determine the suitable thickness and manufacturing material of the leaf spring, and when the leaf spring has enough elasticity to resist impact and vibration, the strength of the leaf spring is reduced, resulting in a reduction of the supporting effect of the leaf spring, and the controllability of the leaf spring is also reduced. In addition, when the linear vibration motor is assembled, the leaf spring is prone to being bent, damaged or even broken.

Therefore, it needs to provide a linear vibration motor capable of solving the above technical problems.

### SUMMARY

The present disclosure provides a linear vibration motor which has high reliability and excellent impact resistance and vibration resistance.

In an aspect, an embodiment of the present disclosure provides a linear vibration motor, including: a case having a receiving space; a vibrator including a support frame and a follower fixed to the support frame, the support frame being arranged in the receiving space, and the support frame being provided with a plurality of receiving grooves; a driver provided opposite to the follower, the driver being arranged in the receiving space, and the driver being configured to drive the follower to drive the support frame to move along a straight line; and a plurality of support members. Each of the plurality of receiving grooves is provided with at least one of the plurality of support members, a part of one of the plurality of support members is located outside the receiving groove, the plurality of support frames press the plurality of support members against the case; and when the driver drives the support frame to move relative to the case, the support member rolls relative to the case and the support frame.

As an improvement, the linear vibration motor further includes a second magnetic member arranged at the case, the driver is a coil, and the coil is arranged at the case; the follower is a first magnetic member, the second magnetic member is disposed opposite to the first magnetic member, and the second magnetic member is configured to cooperate with the first magnetic member to maintain the support frame at an initial position when the coil is powered off, and drive the first magnetic member to drive the support frame to move along the straight line when the coil is powered on; or the linear vibration motor further includes a second magnetic member arranged at the support frame, the driver is a first magnetic member, and the first magnetic member is arranged at the case; the follower is a coil, the second magnetic member is disposed opposite to the first magnetic member, and the second magnetic member is configured to cooperate with the first magnetic member to maintain the support frame at an initial position when the coil is powered off, and the second magnetic member is further configured to be driven to drive the support frame to move along the straight line when the coil is powered on.

As an improvement, the case includes a front shell and a base, the front shell is of a groove structure, and the base covers the groove structure to enclose the receiving space with the groove structure; and the receiving groove is arranged at a side of the support frame facing the front shell and extends along the straight line, an inner wall of the receiving groove and an inner wall of the front shell clamp and fix the support member, and the support member is a ball.

As an improvement, the inner wall of the front shell includes a front wall opposite to the support frame, and a side wall surrounding the front wall and connected to the front wall; the inner wall of the receiving groove includes an inclined wall which forms an included angle with the front wall; and the ball is located between the front wall, the side wall and the inclined wall.

As an improvement, the included angle between the inclined wall and the front wall is within a range from 30° to 60°.

As an improvement, an anti-collision portion is provided at a side of the support frame away from the receiving groove, and in a direction perpendicular to the base, a width of a gap between the anti-collision portion and the base is less than a height of the support member; and the anti-collision portion is configured to prevent the support frame from colliding with the base.

As an improvement, the case includes a front shell and a base, the front shell is a groove structure, the base covers the groove structure to enclose the receiving space with the groove structure; and the receiving groove is arranged at a side of the support frame facing the base and extends along the straight line, an inner wall of the receiving groove and the base clamp and fix the support member, and the support member is a ball.

As an improvement, the front shell includes a side wall surrounding the base and connected to the base, an inner wall of the receiving groove includes an inclined wall which forms an included angle with the base, and the ball is located between the base, the side wall and the inclined wall.

As an improvement, the included angle between the inclined wall and the base is within a range from 30° to 60°.

As an improvement, an anti-collision portion is provided at a side of the support frame away from the receiving groove, and in a direction perpendicular to the base, a width of a gap between the anti-collision portion and the base is less than a height of the support member; and the anti-collision portion is configured to prevent the support frame from colliding with the front shell.

As an improvement, the second magnetic member is a magnetic yoke.

As an improvement, the second magnetic member is magnetic steel, and a magnetic pole of the second magnetic member is arranged opposite to a magnetic pole of the first magnetic member.

In another aspect, an embodiment of the present disclosure provides an electronic device, including a device body and a linear vibration motor arranged at the device body. The linear vibration motor includes: a case having a receiving space; a vibrator including a support frame and a follower fixed to the support frame, the support frame being arranged in the receiving space, and the support frame being provided with a plurality of receiving grooves; a driver provided opposite to the follower, the driver being arranged in the receiving space, and the driver being configured to drive the follower to drive the support frame to move along a straight line; and a plurality of support members. Each of the plurality of receiving grooves is provided with at least one of the plurality of support members, a part of one of the plurality of support members is located outside the receiving groove, the plurality of support frames press the plurality of support members against the case; and when the driver drives the support frame to move relative to the case, the support member rolls relative to the case and the support frame.

Compared with the solution in the related art, in the embodiments of the present disclosure, in a receiving space enclosed by the case, a follower is arranged at a support frame of the vibrator, and the driver is disposed opposite to the follower for driving the follower to drive the support frame to move along a straight line. The support frame is provided with a plurality of receiving grooves, each receiving groove is provided with at least one support member, and a part of the support member is located outside the receiving groove. The support member is pressed against the case by the support frame, the support member is configured to support the support frame, and when the driver drives the support frame to move relative to the case, the support member rolls relative to the case and the support frame, so that the support frame can stably move, and the receiving groove is located in the receiving space and does not deform due to the influence of an impact.

### BRIEF DESCRIPTION OF DRAWINGS

One or more embodiments are exemplarily described in the corresponding figures, and these exemplified descriptions do not constitute limitations on the embodiments. Elements with a same reference numeral in the figures represent similar elements, and unless otherwise stated, the figures do not represent proportional limitations.

FIG. 1 is a three-dimensional structural schematic diagram of a linear vibration motor according to Embodiment I of the present disclosure;

FIG. 2 is a schematic diagram of a front view of a linear vibration motor according to Embodiment I of the present disclosure;

FIG. 3 is a schematic diagram of a side view of a linear vibration motor according to Embodiment I of the present disclosure;

FIG. 4 is a schematic diagram of assembly of internal components of a linear vibration motor according to Embodiment I of the present disclosure;

FIG. 5 is a schematic diagram of an exploded view of a linear vibration motor according to Embodiment I of the present disclosure;

FIG. 6 is an enlarged view of a region S1 shown in FIG. 5;

FIG. 7 is a cross section along AA′ shown in FIG. 2;

FIG. 8 is an enlarged view of a portion shown in FIG. 7;

FIG. 9 is a cross section along BB′ shown in FIG. 2;

FIG. 10 is a cross sectional of a linear vibration motor according to Embodiment I of the present disclosure, where a second magnetic member of the linear vibration motor is a magnetic steel;

FIG. 11 is a schematic diagram of another configuration of a linear vibration motor according to Embodiment I of the present disclosure;

FIG. 12 is a schematic diagram of another configuration of a linear vibration motor according to Embodiment I of the present disclosure;

FIG. 13 is a schematic diagram of a configuration of a linear vibration motor according to Embodiment II of the present disclosure;

FIG. 14 is a schematic diagram of another configuration of a linear vibration motor according to Embodiment II of the present disclosure;

FIG. 15 is a three-dimensional structural schematic diagram of an electronic device according to Embodiment III of the present disclosure;

FIG. 16 is a three-dimensional structural schematic diagram of another electronic device according to Embodiment III of the present disclosure; and

FIG. 17 is a three-dimensional structural schematic diagram of another electronic device according to Embodiment III of the present disclosure.

### REFERENCE SIGNS

100 linear vibration motor
10 case
11 receiving space
12 front shell
13 base
20 vibrator
21 support frame
211 receiving groove
2111 inclined wall
2112 bottom wall
2113 upper wall
212 anti-collision portion
213 avoidance groove
22 follower
30 driver
40 support member
50 second magnetic member
60 circuit board
200 electronic device
210 device body

### DESCRIPTION OF EMBODIMENTS

In order to better illustrate objectives, technical solutions, and advantages of embodiments of the present disclosure, the technical solutions in embodiments of the present disclosure are described in details with reference to the accompanying drawings in the following description. Those of ordinary skill in the art should understand that in the embodiments of the present disclosure, various technical details are set forth for the reader to better understand the present disclosure, but without these technical details and various variations and modifications based on the following embodiments, the technical solutions claimed in the present disclosure can still be implemented.

In the embodiments of the present disclosure, terms such as “upper”, “lower”, “left”, “right”, “front”, “back”, “top”, “bottom”, “inside”, “outside”, “middle”, “vertical”, “horizontal”, “lateral”, “longitudinal” and the like indicating directions or positional relationships are based on orientations or positional relationships shown in the accompanying drawings. These terms are mainly used to better describe the present disclosure and the implementation manners thereof, and are not used to limit that the device, element or component must have such a specific orientation, or be constructed and operated in such a specific orientation.

Further, in addition to indicating an orientation or a location relationship, some of the terms may also indicate other meanings, for example, the term “upper” may also indicate some attachment relationship or connection relationship in some cases. For those skilled in the art, the specific meanings of these terms in the present disclosure may be understood according to specific situations.

In addition, the terms “install”, “arrange”, “provided with”, “form”, “connect” and “join” and the like shall be understood in a broad sense. For example, “connection” may refer to “fixed connection”, “detachable connection”, or “integral connection as a whole”; may refer to “mechanical connection”, or “electrical connection”; and may refer to “direct connection”, or “indirect connection through an intermediate medium”, or “internal communication between two devices, elements, or components. For those skilled in the art, the specific meaning of these terms in the present disclosure may be understood according to specific conditions.

In addition, the terms “first”, “second” and the like are mainly used to distinguish different devices, elements or components (specific types and configurations may be the same or different), and are not used to indicate or imply relative importance and quantity of the indicated devices, elements or components. Unless otherwise indicated, “a plurality of” means two or more.

The implementation details of the linear vibration motor and the electronic device of the present disclosure are described in details below, and the following contents are only implementation details provided for ease of understanding, and are not necessary for implementing the present solution.

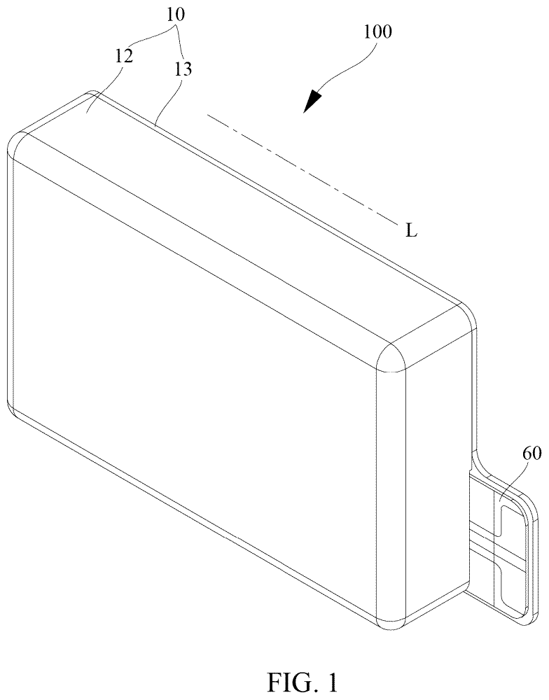

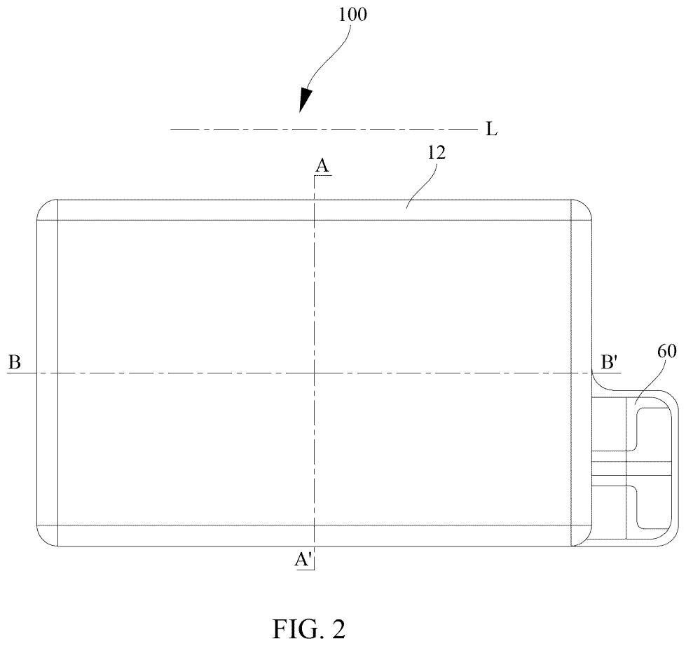

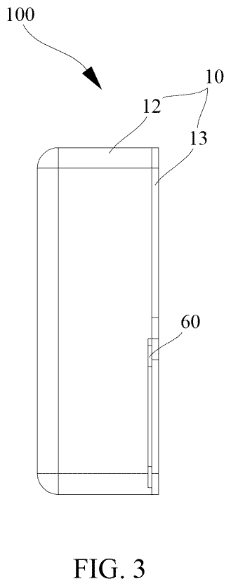

Referring to FIG. 1 to FIG. 9, Embodiment I of the present disclosure provides a linear vibration motor 100, including: a case 10, a vibrator 20, a driver 30, and a plurality of support members 40. The case 10 has a receiving space 11, the vibrator 20 includes a support frame 21 and a follower 22 fixed to the support frame 21, and the support frame 21 is located in the receiving space 11. The driver 30 is arranged opposite to the follower 22. The driver 30 is also located in the receiving space 11, and the driver 30 is configured to drive the follower 22 to drive the support frame to move along a straight line L. The support frame 21 is provided with a plurality of receiving grooves 211, each of which is provided with at least one support member 40, and a part of the support member 40 is located outside the receiving groove 211. The support member 40 is pressed on the case 10 by the support frame 21. When the driver 30 drives the support frame 21 to move, the support member 40 rolls relative to the support frame 21.

In this way, when the driver 30 drives the follower 22 to make the support frame 21

move along with the follower 22, the support member 40 not only can support the support frame 21, but also can allow the support frame 21 to move back and forth relative to itself along the straight line L, so that the linear vibration motor 100 can vibrate back and forth. Moreover, since the receiving groove 211 is located inside the receiving space 11 of the case 10, it will not deform under an action of falling impact and the like, and normal movement of the support member 40 will not be affected. Thus, the linear vibration motor 100 has good impact resistance and vibration resistance.

In this embodiment, the case 10 includes a front shell 12 and a base 13, the front shell 12 is of a groove structure, and the base 13 covers the groove structure to define a receiving space 11 together with the groove structure. For example, the front shell 12 is of a square groove structure, the base 13 is of a square plate structure, and the base 13 covers an opening of the square groove structure, to form the receiving space 11. The front shell 12 and the base 13 may be fixed to each other by welding or bonding, so as to form an integrated structure, which may have excellent waterproof performance and dustproof performance. Further, the front shell 12 and the base 13 may be made of a material with high strength, so as to prevent deformation of the case 10 due to falling impact and other reasons.

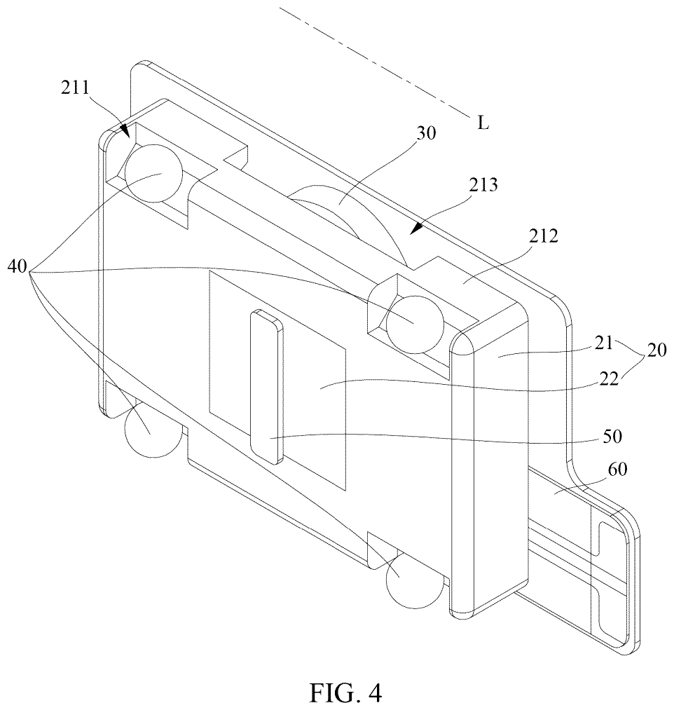

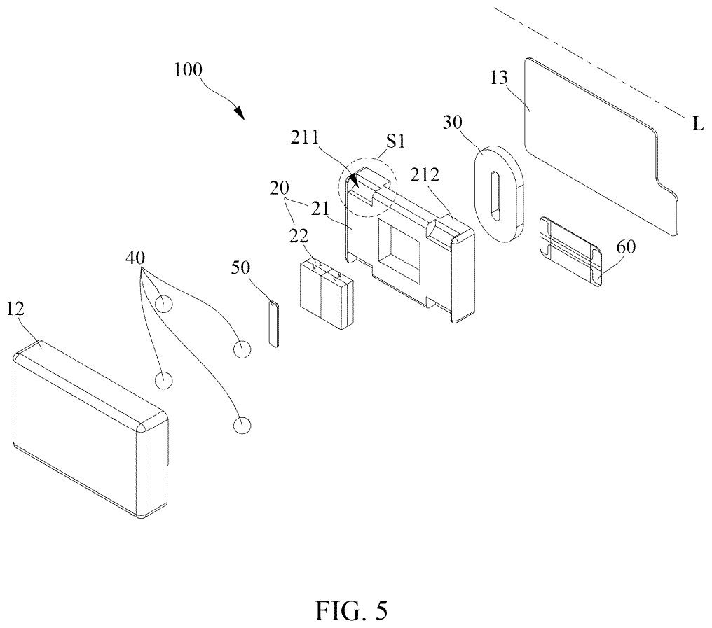

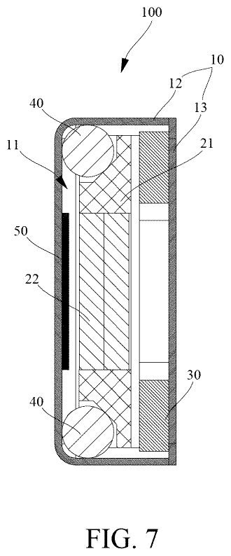

Referring to FIG. 4, FIG. 5 and FIG. 7 again, in the embodiment, the linear vibration motor 100 further includes a second magnetic member 50 arranged at the front shell 12 or the base 13. The driver 30 is a coil, and the coil is arranged at the front shell 12 or the base 13. The follower 22 is a first magnetic member. The second magnetic member 50 is arranged opposite to the first magnetic member, and the second magnetic member 50 is configured to cooperate with the first magnetic member to make the support frame 21 maintain at an initial position when the coil is powered off, and drive the first magnetic member to drive the support frame 21 to move along the straight line L when the coil is powered on.

In addition, the second magnetic member 50 is further configured to make the support frame 21 have a tendency to move towards the case 10 (which may be the front shell 12 or the base 13), so that the support frame 21 can press the support member 40 onto the case 10. In some examples, the second magnetic member 50 arranged at the case 10 is attracted to the first magnetic member arranged at the support frame 21, so that the support frame 21 has a tendency to move towards the front shell 12, thus the front shell 12 and the support frame 21 jointly clamp and fix the ball.

For example, the second magnetic member 50 is arranged at the front shell 12 and the coil is arranged at the base 13. The magnetic field of the second magnetic member 50 itself interacts with the magnetic field of the first magnetic member (such as magnetic steel) itself, and since the second magnetic member 50 is fixed at the front shell 12 and cannot move, the first magnetic member will move under an action of a force. In this embodiment, the second magnetic member 50 is configured to attract the first magnetic member, and the second magnetic member is arranged at a central position of the front shell 12. In this way, in an initial state (when the coil is powered off), the second magnetic member 50 can attract the first magnetic member to maintain it in an initial position; and when the coil is powered on, the coil generates a magnetic field, and the magnetic field generated by the coil interacts with the magnetic field of the first magnetic member. Since the coil is fixed at the base 13 and does not move, when an acting force of the magnetic field generated by the coil on the first magnetic member is greater than an acting force of the magnetic field of the second magnetic member on the first magnetic member, the first magnetic member moves under the action of a force to deviate from the initial position, thereby driving the support frame 21 to move. By controlling the magnitude and the direction of the current passing through the coil, a direction of the force applied to the first magnetic member can be controlled, so that the support frame 21 can move along an expected direction. When the support frame 21 movers back and forth, vibration of the linear vibration motor 100 is achieved. It should be noted that, when the coil drives the support frame 21 to move, the force of the second magnetic member 50 on the first magnetic member always exists, and the force makes the support frame 21 have a tendency to return to the initial position when the support frame 21 is going away from the initial position. That is, the second magnetic member 50 may serve as a magnetic spring. When the coil is powered off, the magnetic field generated by the coil disappears, so that the first magnetic member is no longer affected by the magnetic field generated by the coil. At this time, the first magnetic member moves to the initial position by the force of the magnetic field of the second magnetic member 50.

In some examples, the second magnetic member 50 may be a magnetic yoke, or may be magnetic steel, or may be magnetic fluid encapsulated and fixed to the front shell 12 or the base 13 by using a seal member, as long as the second magnetic member 50 may serve as a magnetic spring when the coil is powered on and the support frame 21 is driven to move, or can make the first magnetic member maintain at an initial position when the coil is powered off.

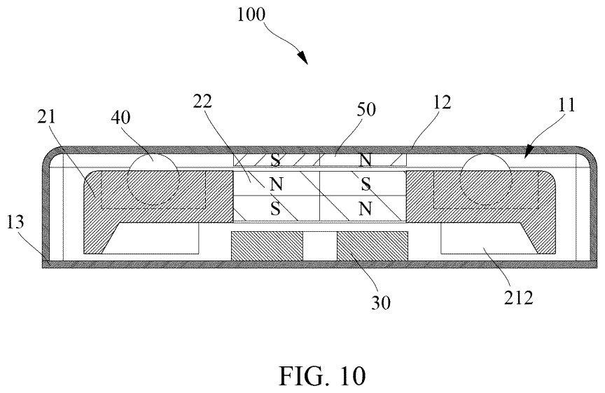

Referring to FIG. 10, it should be noted that, when the first magnetic member and the second magnetic member 50 are both made of magnetic steel, different magnetic poles of the first magnetic member and the second magnetic member 50 need to be oppositely arranged, for example, the N pole of the first magnetic member is opposite to the S pole of the second magnetic member 50, and the S pole of the first magnetic member is opposite to the N pole of the second magnetic member 50. In this way, opposite surfaces of the first magnetic member and the second magnetic member 50 can be attracted to each other.

It can be understood that by adjusting a specification size (such as length, width, and height) of the second magnetic member 50, different acting forces of the second magnetic member 50 on the first magnetic member can be obtained, so that a spring coefficient having a small negative impact on the linear vibration motor 100 can be obtained in the receiving space 11 only by adjusting the second magnetic member 50. Or, different forces of the second magnetic member 50 on the first magnetic member can be obtained through a combination of a plurality of second magnetic members 50, and the spring coefficient can be changed only by changing a combination of the second magnetic members 50 compared with the solutions in the related art in which a leaf spring is used.

It can be understood that positions of the coil and the second magnetic member 50

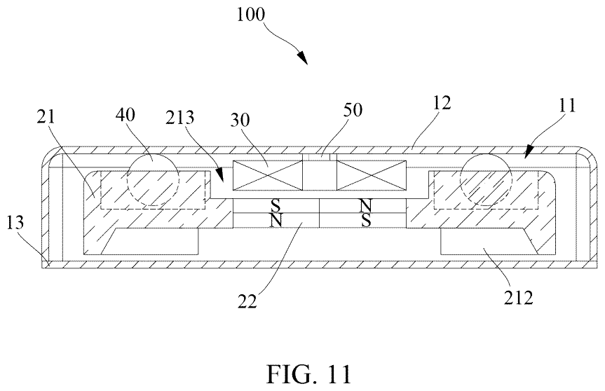

may be interchanged, that is, the coil is arranged at the front shell 12 and the second magnetic member 50 is arranged at the base 13. Or, as shown in FIG. 11, the coil and the second magnetic member 50 may be arranged at a same side, for example, the coil and the second magnetic member 50 are both arranged at the front shell 12, or the coil and the second magnetic member 50 are both arranged at the base 13. In this case, either of the coil and the second magnetic member 50 may be directly arranged at the front shell 12 or the base 13, and the other is arranged at a side of the former away from the front shell 12 or the base 13.

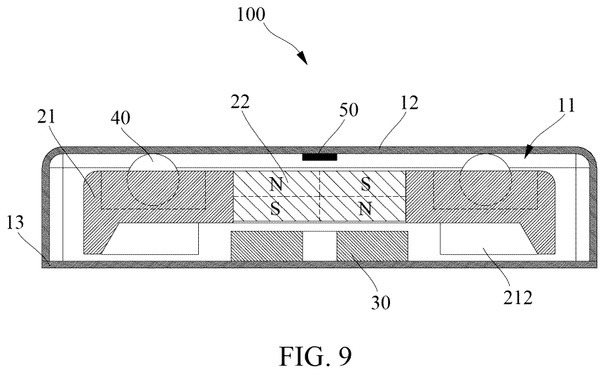

Referring to FIG. 9 to FIG. 11, in an embodiment of the present disclosure, the receiving groove 211 is provided at a side of the support frame 21 facing the front shell 12, that is, the receiving groove 211 opens towards or substantially opens towards the front shell 12. The receiving groove 211 extends along a straight line L. An inner wall of the receiving groove 211 and an inner wall of the front shell 12 clamp and fix the support member 40, and the support member 40 is a ball. In this way, in a working process of the linear vibration motor 100, when the support frame 21 moves back and forth, the ball rolls inside the receiving groove 211, so that the support frame 21 can move stably. In other words, as long as the ball rolls normally, a normal working of the linear vibration motor 100 is not affected relative to a specific position of the receiving groove 211 or the front shell 12. Therefore, the linear vibration motor 100 provided by this embodiment of the present disclosure is not easily affected by the assembly precision.

It can be understood that, when the second magnetic member 50 is arranged at the front shell 12, in a drop test or an unexpected drop impact, the attraction between the first magnetic member and the second magnetic member 50 may also reduce possible collision between the support frame 21 and the base 13, and prevent dust generated due to abrasion of the support frame 21 and/or the base 13 caused by friction when the support frame 21 and the base 13 collide.

In an example, the support member 40 is a roller, and the support member 40 is arranged at a side of the support frame 21 facing the front shell 12. The wheel axle of the roller is fixed to the support frame 21, the axial direction of the wheel axle is parallel to the base 13, and the roller may rotate by taking the axis of the wheel axle as a rotation axis. When the support frame 21 moves, the roller rolls at the front shell 12.

In this embodiment, at least three receiving grooves 211 are provided, and at least one receiving groove 211 is arranged at a position that is not in the same straight line as the positions of the other receiving grooves 211. For example, exactly three receiving grooves 211 are provided, and the positions of the three receiving grooves 211 are in a same plane and form a triangle, so that the support frame 21 does not flip over relative to the front shell 12.

In this embodiment, the support frame 21 is of a square ring shape, four receiving grooves 211 are provided. The four receiving grooves 211 are located at four corners of the support frame 21, and a respective one ball is provided at each of at least three receiving grooves 211. In other embodiments, more than four receiving grooves 211 may be provided.

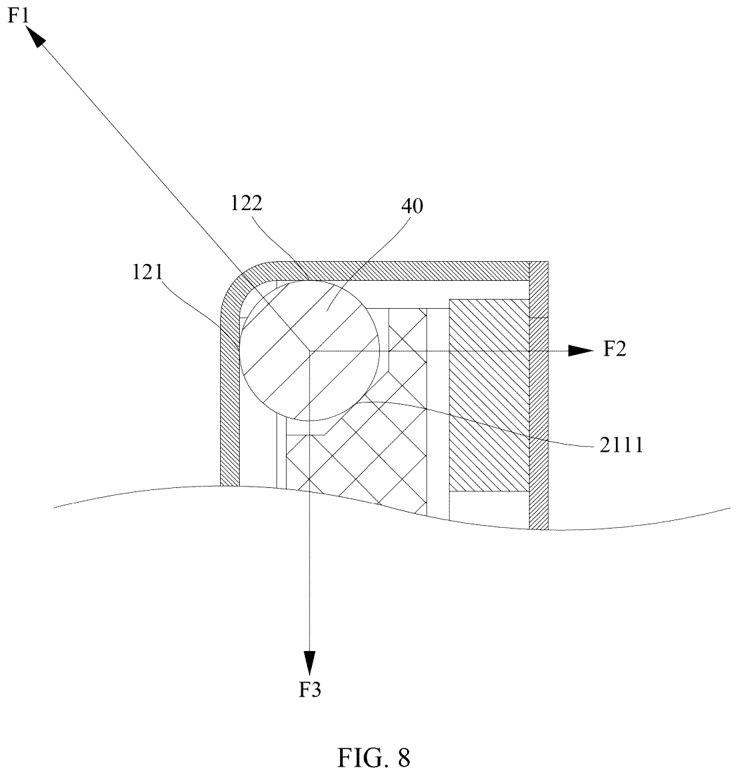

In an example, the inner wall of the front shell 12 includes a front wall 121 opposite to the support frame 21, and a side wall 122 surrounding the front wall 121 and connected to the front wall 121. The inner wall of the receiving groove 211 includes an inclined wall 2111 which forms an included angle with the front wall 121. The balls are located between the front wall 121, the side wall 122, and the inclined wall 2111. Referring to FIG. 8, taking the ball located at an upper position shown in FIG. 7 as an example, under an action of the attraction of the first magnetic member and the second magnetic member 50, the inclined wall 2111 applies an inclined upper left force F1 to the ball, the front wall 121 applies a horizontal right force F2 to the ball, and the side wall 122 applies a vertical downward force F3 to the ball. When the support frame 21 is in a static state, the effects of these forces reach balance, and the position of the ball is maintained. Under the action of these forces, when the support frame 21 is driven to move, the balls may only roll along the straight line L. Since the support frame 21 is supported by the ball, the support frame 21 may only move along the direction of the straight line L. For the ball located at a lower position, the inclined wall 2111 of the corresponding receiving groove 211 applies an inclined downward left force, and the side wall 122 corresponding to this position applies a vertical upward force.

In some examples, the included angle between the inclined wall 2111 and the front wall 121 is within a range from 30° to 60°, for example, 45°.

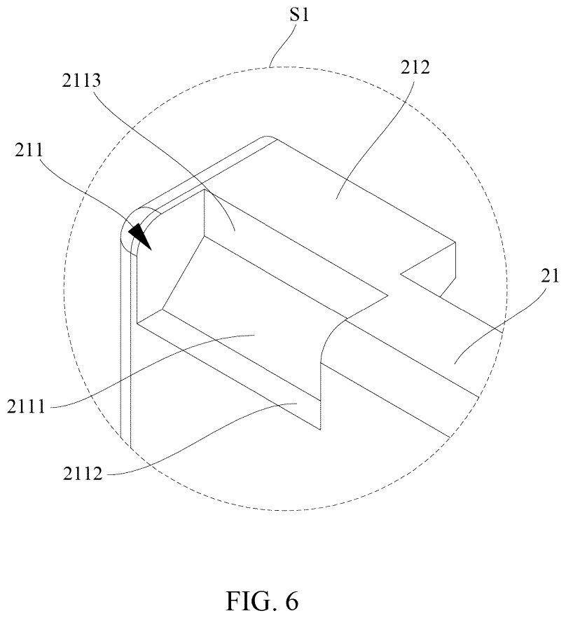

Referring to FIG. 6, in this embodiment, the receiving groove 211 further includes a bottom wall 2112 and an upper wall 2113 both connected to the inclined wall 2111. The bottom wall 2112 is perpendicular to the front wall 121, and the upper wall 2113 is parallel to the front wall 121. In some cases, both the bottom wall 2112 and the upper wall 2113 may limit the position of the ball, ensuring that the ball is at a correct position.

Referring to FIG. 4 to FIG. 6, in an example, the support frame 21 is provided with an anti-collision portion 212 at a side away from the receiving groove 211, and in a direction perpendicular to the base 13, a width of a gap between the anti-collision portion 212 and the base 13 is less than a height of the support member 40. The anti-collision portion 212 is configured to prevent the support frame 21 from colliding with the base 13. In a drop test or an unexpected drop impact, the anti-collision portion 212 may abut against the base 13 before the support frame 21 contacts the coil or the base 13, thereby avoiding damage to the support frame 21 or preventing the first magnetic member from disengaging from the support frame 21 due to impact.

The width of the gap between the anti-collision portion 212 and the base 13 is smaller than a diameter of the ball. Even if the anti-collision portion 212 is in full contact with the base 13, the width of the gap between the support frame 21 and the front shell 12 is smaller than the diameter of the ball, which may prevent the ball from separating from the receiving groove 211. In this way, the action of the falling impact is slowed down, or after the falling impact is finished, under an action of the first magnetic member and the second magnetic member 50, the support frame 21 is back to an initial position and the ball moves back to the inclined wall 2111.

It should be noted that when the first magnetic member is arranged at the support frame 21, and the coil and the anti-collision portion 212 are both located at a same side of the support frame 21, in a direction perpendicular to the base 13, the height of the anti-collision portion 212 should be greater than the height of the coil. In this case, when the anti-collision portion 212 contacts the base 13 due to the falling impact, the support frame 21 or the first magnetic member does not contact the coil. If the coil and the anti-collision portion 212 are arranged at two opposite sides (that is, not at a same side) of the support frame 21, the support frame 21 may be provided with an avoidance groove 213 for avoiding the coil. When the support frame 21 firmly presses the ball, a distance between a bottom of the avoidance groove 213 and the case 10 should be greater than the height of the coil.

In order to improve the impact resistance of the anti-collision portion 212, the anti-collision portion 212 may be formed by a material having certain elasticity, such as rubber or other material, and the anti-collision portion 212 may also be integrally formed with the support frame 21.

During the working process of the linear vibration motor 100, the attraction between the first magnetic member and the second magnetic member 50 may also cause a certain gap between the anti-collision portion 212 and the base 13, so that the linear vibration motor 100 may continuously and stably output.

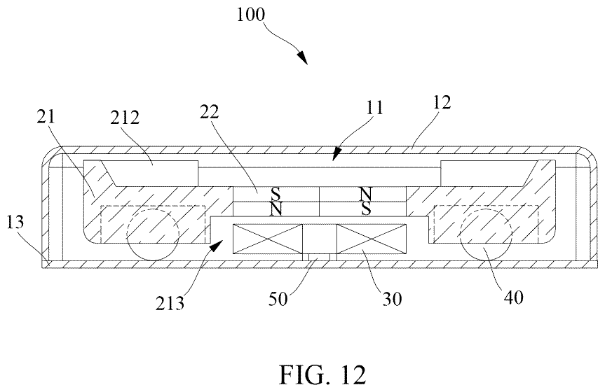

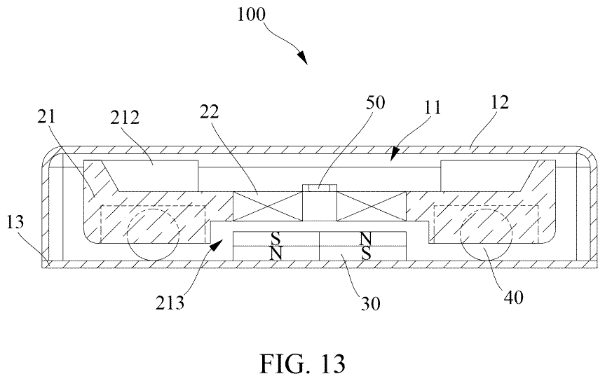

Referring to FIG. 12 and FIG. 13, in other examples, the receiving groove 211 is arranged at a side of the support frame 21 facing the base 13 and extends along the straight line L, and the inner wall of the receiving groove 211 and the base 13 clamp and fix the ball. In this case, since the support frame 21 and the base 13 need to jointly clamp and fix the ball, the second magnetic member 50 may be arranged at the base 13, for example, at a center position of the base 13. In this case, the ball is located between the base 13, the side wall 122 and the inclined wall 2111. In this case, the base 13 applies a horizontal leftward force to the ball, the side wall 122 applies a vertical downward force to the ball, and the inclined wall 2111 applies an inclined rightward force to the ball. When these forces are balanced, the position of the ball is maintained.

It can be understood that when the receiving groove 211 opens towards the base 13, the anti-collision portion 212 is arranged at a side of the support frame 21 facing the front shell 12.

Referring to FIG. 5, in an example, the linear vibration motor 100 further includes a circuit board 60. The circuit board 60 is electrically connected to the coil to supply power to the coil. When the coil is fixed to the front shell 12, the circuit board 60 may also be fixed to the front shell 12; and when the coil is fixed to the base 13, the circuit board 60 may also be fixed to the base 13.

Further, in order to connect the circuit board 60 from the outside of the case 10, a connection end of the circuit board 60 may be exposed to the outside of the case 10, so that a probe with a spring may be used for contact connection, or a solder connection may be used, or an ACF (Anisotropic Conductive Film) may be used for electrical connection to the controller of the electronic device.

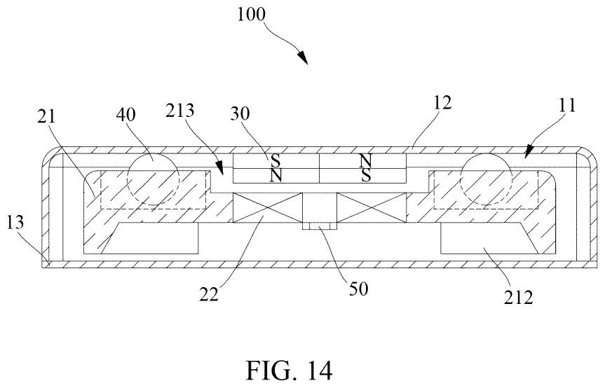

Referring to FIG. 13 and FIG. 14, Embodiment II of the present disclosure provides a linear vibration motor 100, which is substantially the same as the linear vibration motor 100 of Embodiment I, and s main difference is as follows: the second magnetic member 50 is arranged at the support frame 21, the driver 30 is the first magnetic member, and the follower 22 is a coil. When the coil is powered off, the second magnetic member 50 is attracted by the first magnetic member, so that the support frame 21 is maintained at the initial position; and when the coil is powered on, the magnetic field generated by the coil interacts with the first magnetic member, and because the position of the first magnetic member is fixed, the coil drives the support frame 21 to move along the straight line L to deviate from the initial position.

In this case, the second magnetic member 50 may be located between the follower 22 and the driver 30, or may be located at a side of the follower 22 away from the driver 30. In some examples, the second magnetic member is arranged at a side of the follower 22 away from the driver 30, so that a certain gap may be maintained between the vibrator 20 and the driver 30, thereby avoiding contact between the vibrator 20 and the driver 30 during impact.

Since the first magnetic member is fixed to the case 10, the height of the anti-collision portion 212 should be greater than the height of the first magnetic member; or when the support frame 21 firmly presses the ball, a distance between the bottom of the avoidance groove 213 at the support frame 21 and the case 10 should be greater than the height of the first magnetic member.

In this case, since the coil will move continuously when the linear vibration motor 100 works, the circuit board 60 is at least partially configured to be flexible to deform in cooperation with the movement of the coil.

According to the above-described embodiments, it can be found that either of the first magnetic member and the coil can be arranged at the support frame 21, and the other one is arranged at the case 10, and the specific arrangement manner is not specifically limited herein. The same is true for the first magnetic member and the second magnetic member 50, either of which is arranged at the support frame 21 and the other one is arranged at the case 10. The magnetic member arranged at the case 10 needs to be disposed opposite to the opening of the receiving groove 211, to ensure that the case 10 and the support frame 21 can clamp the ball.

For a traditional leaf spring structure, in a drop test or an unexpected drop impact, the shock that cannot be absorbed causes the vibrator 20 to vibrate vigorously relative to the case 10, and this vibration has a large damage to the components of the vibrator 20 and other components fixed to the case 10, also, the leaf spring structure is prone to damage due to stress concentration and the like. In the embodiments of the present disclosure, a traditional leaf spring structure is omitted, and the design of the magnetic spring is achieved by the attraction effect between the first magnetic member and the second magnetic member 50. In this way, the reliability reduction and spring breakage caused by metal fatigue can be avoided, and the spring coefficient of the magnetic spring can be changed by adjusting the length, width and height of the second magnetic member 50 to achieve various changes, thereby reducing the design difficulty and reducing the limiting factors for designing the linear vibration motor 100. Moreover, the attraction between the first magnetic member and the second magnetic member 50 makes the vibrator 20 not always contact the case 10, and even in a drop test and an unexpected drop impact, this attraction may reduce the vibration of the vibrator 20, and the sliding support of the ball on the support frame 21 can also reduce the negative effect caused by the impact, thereby improving the impact resistance and vibration resistance of the linear vibration motor 100.

In addition, for a conventional leaf spring structure, the assembly precision of the linear vibration motor, a posture or state of the handheld electronic device, and a state of falling impact may cause contact (or collision) between the vibrator and the case (or stator). In the embodiments of the present disclosure, the vibrator 20 is slidably supported by the ball, and is continuously fixed by attraction of the first magnetic member and the second magnetic member 50, so that a certain gap can be maintained between the vibrator 20 and the case 10 (or the stator). Moreover, a side of the support frame 21 away from the ball is also provided with an anti-collision portion 212, and even in a case of accidental falling, the anti-collision portion 212 will first contact the case 10 to prevent the vibrator 20 from contacting the case 10 (or the stator).

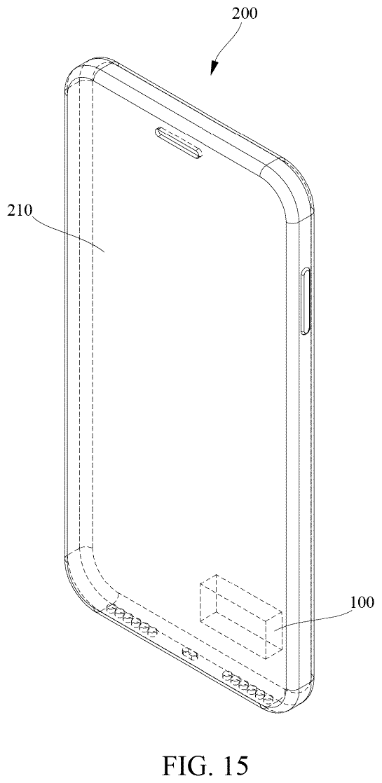

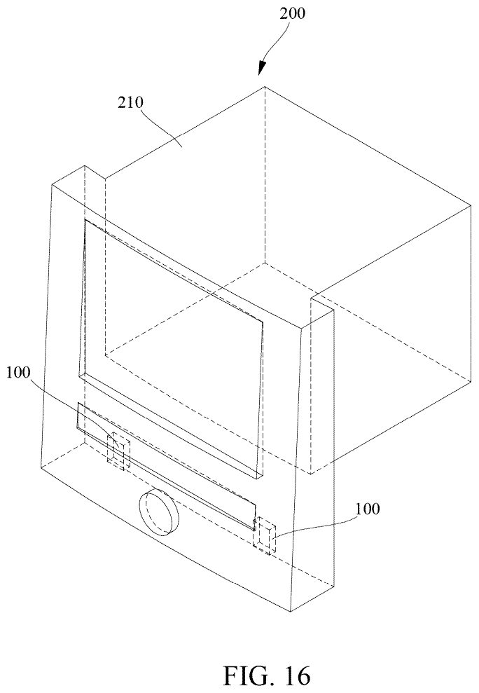

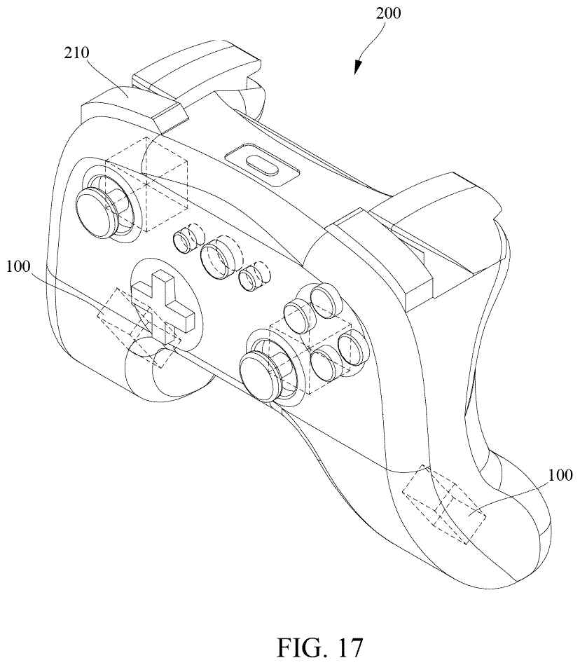

Referring to FIG. 15 to FIG. 17, Embodiment III of the present disclosure provides an electronic device 200, including a device body 210 and the linear vibration motor 100 described in Embodiment I or Embodiment II, and the linear vibration motor 100 is arranged at the device body 210. Moreover, the number and specific positions of the linear vibration motors 100 provided at the device body 210 may be selected and configured according to actual requirements.

In this embodiment, the electronic device 200 may be a portable electronic device such as a mobile phone or a tablet computer, or may be an electronic device using a linear vibration motor as a feedback device such as an automobile navigation system or a vehicle-mounted instrument panel, or may be a plurality of electronic devices including tactile feedback in a wearable device.

The linear vibration motor and the electronic device provided by the embodiments of the present disclosure are described in details in the above description, the principles and the embodiments of the present disclosure are described herein by using specific examples, and the description of the above embodiments is merely used to help understand the idea of the present disclosure, and there will be changes in the specific embodiments and application ranges. In summary, the contents of the present disclosure should not be construed as limiting the present disclosure.

What is claimed is:

1. A linear vibration motor, comprising:
a case having a receiving space;
a vibrator comprising a support frame and a follower fixed to the support frame, wherein the support frame is arranged in the receiving space, and the support frame is provided with a plurality of receiving grooves;
a driver provided opposite to the follower, wherein the driver is arranged in the receiving space, and the driver is configured to drive the follower to drive the support frame to move along a straight line; and
a plurality of support members, wherein each of the plurality of receiving grooves is provided with at least one of the plurality of support members, a part of one of the plurality of support members is located outside the receiving groove, the plurality of support frames press the plurality of support members against the case; and when the driver drives the support frame to move relative to the case, the support member rolls relative to the case and the support frame.

2. The linear vibration motor as described in claim 1,
wherein the linear vibration motor further comprises a second magnetic member arranged at the case, the driver is a coil, and the coil is arranged at the case; the follower is a first magnetic member, the second magnetic member is disposed opposite to the first magnetic member, and the second magnetic member is configured to cooperate with the first magnetic member to maintain the support frame at an initial position when the coil is powered off, and drive the first magnetic member to drive the support frame to move along the straight line when the coil is powered on; or
wherein the linear vibration motor further comprises a second magnetic member arranged at the support frame, the driver is a first magnetic member, and the first magnetic member is arranged at the case; the follower is a coil, the second magnetic member is disposed opposite to the first magnetic member, and the second magnetic member is configured to cooperate with the first magnetic member to maintain the support frame at an initial position when the coil is powered off, and the second magnetic member is further configured to be driven to drive the support frame to move along the straight line when the coil is powered on.

3. The linear vibration motor as described in claim 2, wherein the case comprises a front shell and a base, the front shell is of a groove structure, and the base covers the groove structure to enclose the receiving space with the groove structure; and the receiving groove is arranged at a side of the support frame facing the front shell and extends along the straight line, an inner wall of the receiving groove and an inner wall of the front shell clamp and fix the support member, and the support member is a ball.

4. The linear vibration motor as described in claim 3, wherein the inner wall of the front shell comprises a front wall opposite to the support frame, and a side wall surrounding the front wall and connected to the front wall; the inner wall of the receiving groove comprises an inclined wall which forms an included angle with the front wall; and the ball is located between the front wall, the side wall and the inclined wall.

5. The linear vibration motor as described in claim 4, wherein the included angle between the inclined wall and the front wall is within a range from 30° to 60°.

6. The linear vibration motor as described in claim 3, wherein an anti-collision portion is provided at a side of the support frame away from the receiving groove, and in a direction perpendicular to the base, a width of a gap between the anti-collision portion and the base is less than a height of the support member; and the anti-collision portion is configured to prevent the support frame from colliding with the base.

7. The linear vibration motor as described in claim 2, wherein the case comprises a front shell and a base, the front shell is a groove structure, the base covers the groove structure to enclose the receiving space with the groove structure; and the receiving groove is arranged at a side of the support frame facing the base and extends along the straight line, an inner wall of the receiving groove and the base clamp and fix the support member, and the support member is a ball.

8. The linear vibration motor as described in claim 7, wherein the front shell comprises a side wall surrounding the base and connected to the base, an inner wall of the receiving groove comprises an inclined wall which forms an included angle with the base, and the ball is located between the base, the side wall and the inclined wall.

9. The linear vibration motor as described in claim 8, wherein the included angle between the inclined wall and the base is within a range from 30° to 60°.

10. The linear vibration motor as described in claim 7, wherein an anti-collision portion is provided at a side of the support frame away from the receiving groove, and in a direction perpendicular to the base, a width of a gap between the anti-collision portion and the base is less than a height of the support member; and the anti-collision portion is configured to prevent the support frame from colliding with the front shell.

11. The linear vibration motor as described in claim 2, wherein the second magnetic member is a magnetic yoke.

12. The linear vibration motor as described in claim 2, wherein the second magnetic member is magnetic steel, and a magnetic pole of the second magnetic member is arranged opposite to a magnetic pole of the first magnetic member.

13. An electronic device, comprising a device body and a linear vibration motor arranged at the device body, wherein the linear vibration motor comprises:
a case having a receiving space;
a vibrator comprising a support frame and a follower fixed to the support frame, wherein the support frame is arranged in the receiving space, and the support frame is provided with a plurality of receiving grooves;
a driver provided opposite to the follower, wherein the driver is arranged in the receiving space, and the driver is configured to drive the follower to drive the support frame to move along a straight line; and
a plurality of support members, wherein each of the plurality of receiving grooves is provided with at least one of the plurality of support members, a part of one of the plurality of support members is located outside the receiving groove, the plurality of support frames press the plurality of support members against the case; and when the driver drives the support frame to move relative to the case, the support member rolls relative to the case and the support frame.
